(19) United States
(12) Patent Application Publication
(10) Pub. No.: US 2025/0233953 A1
(43) Pub. Date: Jul. 17, 2025

(54) IMAGE READING DEVICE AND IMAGE FORMING APPARATUS THEREWITH

(71) Applicant: KYOCERA Document Solutions Inc., Osaka (JP)

(72) Inventor: Yasuyuki HORIGUCHI, Osaka (JP)

(73) Assignee: KYOCERA Document Solutions Inc., Osaka (JP)

(21) Appl. No.: 19/010,854

(22) Filed: Jan. 6, 2025

(30) Foreign Application Priority Data
Jan. 12, 2024 (JP) 2024-003108

(51) Int. Cl. H04N 1/00; H04N 1/203; H04N 1/407

(52) U.S. Cl. CPC H04N 1/00822; H04N 1/203; H04N 1/407

(57) ABSTRACT

An image reading device includes a contact glass, an automatic document feeder, a first reading module, a second reading module, a first white reference member, a second white reference member, and a control portion. The first reading module reads the image on the front side of a stationary document placed on the contact glass and a conveyed document conveyed to an automatic reading position by the automatic document feeder. The second reading module is disposed in the automatic document feeder and reads the image on the back side of a conveyed document. When performing a duplex reading process to read the images on the front and back sides of the conveyed document simultaneously, the control portion, after the duplex reading process is requested, performs offset adjustment, gain adjustment, and acquisition of back-side black reference data and back-side white reference data for the second reading module.

### INCORPORATION BY REFERENCE

This application is based on and claims the benefit of priority from Japanese Patent Application No. 2024-3108 filed on Jan. 12, 2024, the contents of which are hereby incorporated by reference.

### BACKGROUND

The present disclosure relates to an image reading device for use in digital copiers, image scanners, and the like to scan and read a document, and relates also to an image forming apparatus provided with such an image reading device.

Some known image reading devices for incorporation in multifunction peripherals and the like employing an electrophotographic process are provided with an automatic document feeder that feeds a document in the form of sheets sequentially into a document placement stage (contact glass) to read them and that then, after their reading, discharges them off the document placement stage. Such image reading devices are capable of two methods of reading: a sheet-through method in which, with a reading module fixed in an image reading position, a document is read while an automatic document feeder automatically conveys it; and a stationary-document method in which, each time a document is read, a document pressor is opened and closed to change from one sheet to another of the document on a document placement stage and a reading module is moved to scan and read the document placed on the document placement stage.

Today, the sheet-through method mentioned above is achieved typically by a simultaneous duplex reading method in which the front and back sides of a duplex document are read simultaneously by use of different reading modules respectively in a single document conveyance action by the automatic document feeder. The reading module for reading the back side of the document is disposed in the automatic document feeder. An image reading device requires various processes for initial setting, adjustment, and other operation for reading modules, and those processes include a white reference data acquisition process and a black reference data acquisition process whereby, as a light source incorporated in the reading module is lit and extinguished, the data of the amount of light reflected from a white reference plate disposed opposite the reading module is acquired as white reference data and black reference data.

### SUMMARY

According to one aspect of the present disclosure, an image reading device includes a contact glass, an automatic document feeder, a first reading module, a second reading module, a first white reference member, a second white reference member, and a control portion. On the contact glass, a document is placed. The automatic document feeder is provided on the top face of the contact glass so as to be openable and closable with respect to it, and conveys the document to an automatic reading position on the contact glass. The first reading module is disposed below the contact glass so as to be reciprocable in the sub-scanning direction, and can read the image on the front side of a stationary document placed on the contact glass and a conveyed document conveyed to the automatic-reading position by the automatic document feeder. The second reading module is disposed in the automatic document feeder, and can read the image on the back side of the conveyed document. The first white reference member is disposed opposite the first reading module at a position different from the automatic-reading position. The second white reference member is disposed opposite the second reading module. The control portion controls the first and second reading modules. The first reading module includes: a first light source; and a first sensor that reads, as image light, the reflected light of the light shone from the first light source to the conveyed document. The second reading module includes: a second light source; and a second sensor that reads, as image light, the reflected light of the light shone from the second light source to the conveyed document. When the control portion performs, as a conveying reading process for reading an image on the conveyed document, a duplex reading process whereby the images on the front and back sides of the conveyed document are read simultaneously, after the duplex reading process is requested the control portion performs offset adjustment, gain adjustment, and acquisition of back-side black reference data and back-side white reference data for the second reading module.

### BRIEF DESCRIPTION OF THE DRAWINGS

FIG. 1 is a side sectional view showing the overall construction of an image forming apparatus provided with an image reading portion according to the present disclosure.

FIG. 2 is a side sectional view showing the internal structure of an image reading portion according to one embodiment of the present disclosure that is provided with an automatic document feeder.

FIG. 3 is an enlarged view around a front-side reading module in FIG. 2, with the front-side reading module disposed at a reference position.

FIG. 4 is an enlarged view around the front-side reading module in FIG. 2, with the front-side reading module disposed at an automatic-reading position.

FIG. 5 is an enlarged view around a back-side reading module in FIG. 2.

FIG. 6 is a block diagram showing one example of control paths used in the image forming apparatus according to the embodiment.

FIG. 7 is a flow chart showing an example of control for document reading by a sheet-through method in the image reading portion according to the embodiment.

### DETAILED DESCRIPTION

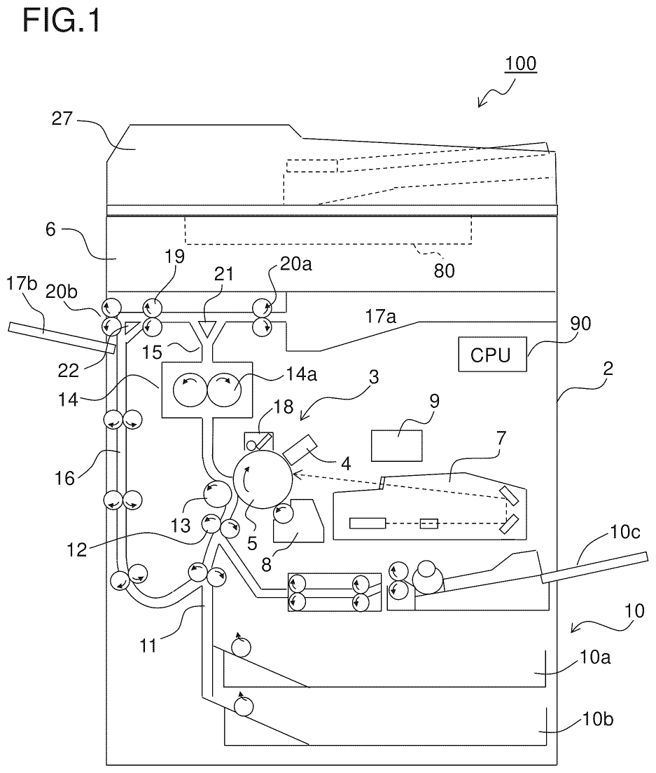

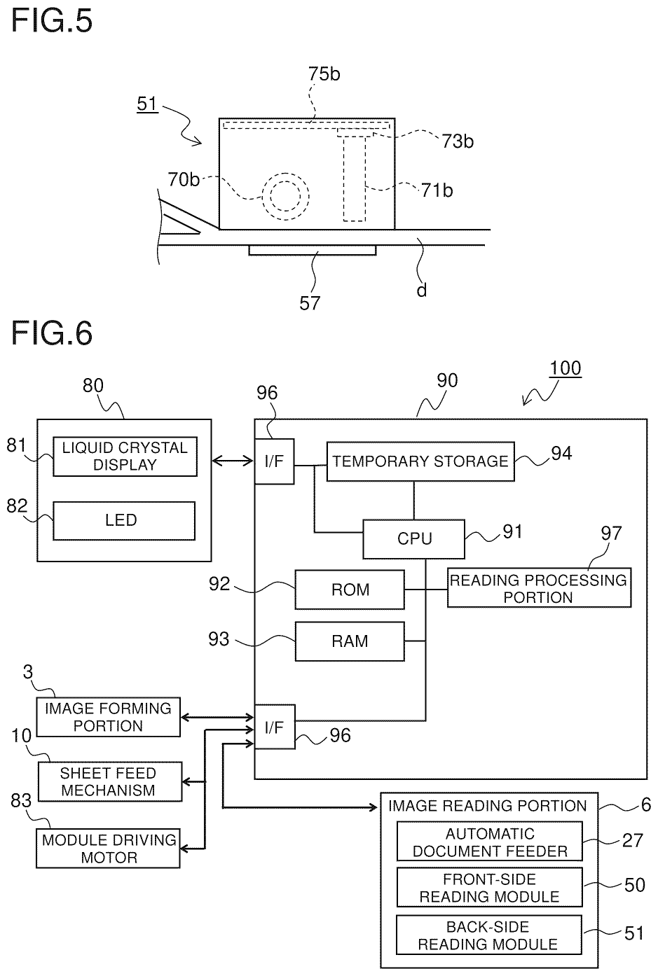

An embodiment of the present disclosure will be described below with reference to the accompanying drawings. FIG. 1 is a schematic construction diagram of an image forming apparatus 100 provided with an image reading portion 6 according to the present disclosure. In FIG. 1, when copying operation is performed on the image forming apparatus 100 (here, a digital multifunction peripheral is taken as an example), the image data of a document is read and converted into a read image signal in an image reading portion 6, which will be described later. On the other hand, in an image forming portion 3 inside a multifunction peripheral body 2, a photosensitive drum 5, which rotates clockwise in FIG. 5, is electrostatically charged uniformly by a charging unit 4. Then, with a laser beam from an exposure unit (such as laser scanning unit) 7, an electrostatic latent image based on the document image data read by the image reading portion 6 is formed on the photosensitive drum 5. To the electrostatic latent image so formed, developer (hereinafter referred to as toner) is attached by a development unit 8 to form a toner image. The toner is supplied to the development unit 8 from a toner container 9.

To the photosensitive drum 5 having the toner image formed as described above, a sheet of paper is conveyed from a sheet feeding mechanism 10 via a sheet conveyance passage 11 and a pair of registration rollers 12 to the image forming portion 3. The conveyed sheet passes through the nip portion between the photosensitive drum 5 and a transfer roller 13 (image transfer portion) and meanwhile the toner image on the surface of the photosensitive drum 5 is transferred to the sheet. The sheet having the toner image transferred to it is separated from the photosensitive drum 5 and is conveyed to a fixing portion 14 having a pair of fixing rollers 14a, where the toner image is fixed. The sheet having passed through the fixing portion 14 is conveyed to a sheet conveyance passage 15 that branches into a plurality of directions. The sheet then has its conveyance direction switched by path switching mechanisms 21 and 22 having a plurality of path switching guides provided at branch points along the sheet conveyance passage 15, so as to be discharged as it is (or after being fed to a reversing conveyance passage 16 to be subjected to duplex copying) to a sheet discharge portion that includes a first discharge tray 17a and a second discharge tray 17b.

Though not shown, a static-eliminating device for eliminating residual electric charge on the surface of the photosensitive drum 5 is provided downstream of a cleaning device 18 with respect to the rotation direction of the photosensitive drum 5. A sheet feed mechanism 10 includes a plurality of sheet feed cassettes 10a and 10b, which are removably mounted in the multifunction peripheral body 2 and which store sheets, and a stack bypass (hand-feed tray) 10c, which is provided above them. These are all connected through a sheet conveyance passage 11 to the image forming portion 3, which includes the photosensitive drum 5, the development unit 8, and the like.

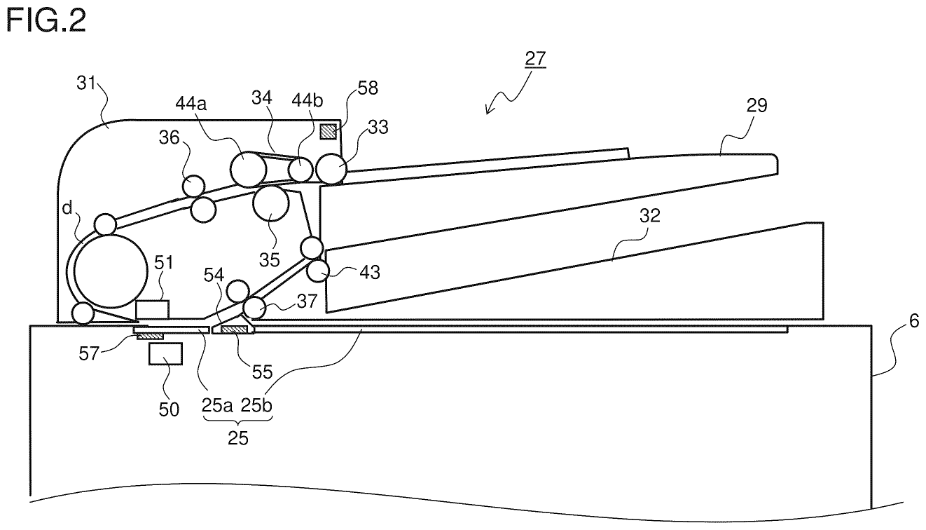

In an upper part of the multifunction peripheral body 2, the image reading portion 6 is disposed and, on the top face of the multifunction peripheral body 2, an automatic document feeder 27 is mounted. The bottom face of the automatic document feeder 27 serves also as a platen that, with the automatic document feeder 27 in a closed state, presses and holds a document placed on a contact glass 25 (see FIG. 2) on the image reading portion 6.

On the front face of the image reading portion 6, an operation portion 80 is provided. The operation portion 80 includes a liquid crystal display and LEDs to indicate the status of the image forming apparatus 100, the progress of image formation, and the number of copies printed. The operation portion 80 also includes a start button with which a user can enter an instruction to start image formation, a stop/clear button that the user can use, for example, to stop image formation, a reset button that the user can use to get the various settings on the image forming apparatus 100 back to the default ones.

Specifically, the sheet conveyance passage 15 first branches, downstream of the pair of fixing rollers 14a, into two, left and right, paths, of which one path (the one branching rightward in FIG. 1) communicates with the first discharge tray 17a. The other path (the path branching leftward in FIG. 1) runs through a pairs of conveyance rollers 19 and branches into two paths, of which one path (the path branching leftward in FIG. 1) communicates with the second discharge tray 17b. The other path (the path branching downward in FIG. 1) communicates with the reversing conveyance passage 16.

Inside the multifunction peripheral body 2, there is also disposed a control portion (CPU) 90 that controls the operation of the image forming portion 3, the image reading portion 6, the automatic document feeder 27, and the like.

FIG. 2 is a side sectional view showing the internal structure of an image reading portion 6 according to one embodiment of the present disclosure which is provided with an automatic document feeder 27. On the top face of the image reading portion 6, a contact glass 25 is disposed that comprises an automatic reading glass 25a and a hand-placed document glass 25b.

Inside the image reading portion 6, a front-side reading module 50 (first reading module) is disposed. The front-side reading module 50, while moving in the sub-scanning direction (left-right direction in FIG. 2), reads the image of a document placed on the hand-placed document glass 25b. In a state at rest immediately below the automatic reading glass 25a, the front-side reading module 50 reads the image on the front side (bottom side) of a document conveyed by the automatic document feeder 27.

Between the automatic reading glass 25a and the hand-placed document glass 25b, a conveyance guide 54 is disposed that lifts up the leading edge of the document conveyed by the automatic document feeder 27. Under the conveyance guide 54, a front-side white reference plate 55 (first white reference member) is disposed for shading correction for the front-side reading module 50.

A cover member 31 of the automatic document feeder 27 is supported so as to be openable and closable with respect to the frame (not shown) of the automatic document feeder 27 about, as a fulcrum, the side (left side in FIG. 2) of the cover member 31 closer to a side face of the apparatus. Inside the cover member 31, there is formed a document conveyance passage d leading from a document feed tray 29 to a document discharge tray 32. Along the document conveyance passage d, there are provided conveyance members, which include a pickup roller 33, a sheet feed belt 34, a separation roller 35, a pair of registration rollers 36, a pair of conveyance rollers 37, a pair of discharge rollers 43, and the like, as well as a back-side reading module 51 (second reading module), which reads the image on the back side of the document.

The document conveyance passage d curves so as to turn back in a portion of it leading from the pair of registration rollers 36 to the automatic reading glass 25a. In the document conveyance passage d, at appropriate places along it, a plurality of sheet sensors (not shown) are provided that include a sheet feed sensor and a discharge sensor for sensing the presence or absence, or the passage, of the document. At a position opposite the back-side reading module 51 across the document conveyance passage d, a back-side white reference plate 57 (second white reference member) is disposed for shading correction for the back-side reading module 51.

The sheet feed belt 34 is stretched around a driving roller 44a and a driven roller 44b and is contacted from below by the separation roller 35 with a predetermined pressure. The separation roller 35 incorporates a torque limiter so that it rotates by following the sheet feed belt 34 only when a rotation load is higher than a predetermined torque.

Inside the cover member 31, an open/close sensor 58 is disposed that senses whether the cover member 31 is open or closed. The open/close sensor 58 is a PI (photo-interrupter) sensor provided with a sensing portion having a light-emitting portion and a light-receiving portion. With the cover member 31 in a closed position as shown in FIG. 2, the open/close sensor 58 is shielded from light by a light-shield plate (not shown) provided on the cover member 31, so that the sensing portion yields a light reception signal with a low level. When from the state in FIG. 2 the cover member 31 pivots in the opening direction (upward), the light-shield plate retracts upward from the sensing portion of the open/close sensor 58, allowing the sensing portion to yield a light reception signal with a high level. The light reception signal of the open/close sensor 58 is transmitted to a control portion 90 (see FIG. 6), which thus senses whether the cover member 31 is open or close.

Next, a description will be given of document reading operation by a sheet-through method using the automatic document feeder 27. In the sheet-through method, with the automatic document feeder 27 in the closed state in contact with the contact glass 25, a plurality of document sheets are set on the document feed tray 29 with the image face up. After that, when a start button on the operation portion 80 (see FIG. 1) of the image forming apparatus 100 is turned on, a lift plate (not shown) raised by a lifting mechanism (not shown) pushes, via the document, the pickup roller 33 up. As a result, the weight of a frame member (not shown) including the pickup roller 33 acts on the lift plate, so that the top face of the document is pressed against the pickup roller 33 with a predetermined pressure (sheet feed pressure).

Here, the pickup roller 33, the driving roller 44a, the driven roller 44b, and the sheet feed belt 34 are disposed on the unshown frame member. The pickup roller 33 is coupled to the driving roller 44a by an unshown gear. As a roller drive motor (unshown) rotates the driving roller 44a, the sheet feed belt 34 stretched around the driving roller 44a and the driven roller 44b is driven to rotate and also the pickup roller 33 is driven to rotate.

Out of the document set on the document feed tray 29, typically a plurality of sheets in a top layer are fed by the pickup roller 33 to the nip portion between the sheet feed belt 34 and the separation roller 35. Then, of those document sheets, only the topmost sheet is separated and conveyed by the separation roller 35 toward the pair of registration rollers 36. Here, after the leading edge of the document is sensed by the sheet feed sensor, the document is conveyed over a predetermined distance; then, the roller drive motor stops being operated and thus the pickup roller 33 and the sheet feed belt 34 stop being driven to rotate, thus ending primary sheet feeding. The primarily fed document stays at rest, with a sag formed in it, at the nip portion between the pair of registration rollers 36.

A predetermined time after the completion of primary sheet feeding, secondary sheet feeding is started. Specifically, a secondary sheet feeding drive motor (unshown) operates to drive the pair of registration rollers 36 to rotate. The document is conveyed, by the pair of registration rollers 36 and the pair of conveyance rollers 37, toward the automatic reading glass 25a. The document conveyed to the automatic reading glass 25a makes contact with a document pressing member (unshown) disposed opposite the automatic reading glass 25a and is thereby pressed from above against the automatic reading glass 25a. The image on the front side (facing the automatic reading glass 25a) of the document is then read through the automatic reading glass 25a by the front-side reading module 50.

After that, the document having passed across the automatic reading glass 25a is conveyed via the conveyance guide 54 toward the pair of conveyance rollers 37 and the pair of discharge rollers 43, to be eventually be discharged by the pair of discharge rollers 43 onto the document discharge tray 32. Meanwhile, the discharge sensor senses the passage of the trailing edge of the document and thereby senses the completion of image reading for one document sheet. Here, the discharge sensor has a counting function to increment the number of document sheets every time the conveyance of a document sheet is complete and, if the sheet feed sensor has sensed a subsequent document sheet, the subsequent and following document sheets are conveyed in a similar manner as described above.

When a duplex document is read, the image on the back side of the document is read by the back-side reading module 51 provided upstream of the automatic reading glass 25a and then the image on the front side of the document is read by the front-side reading module 50.

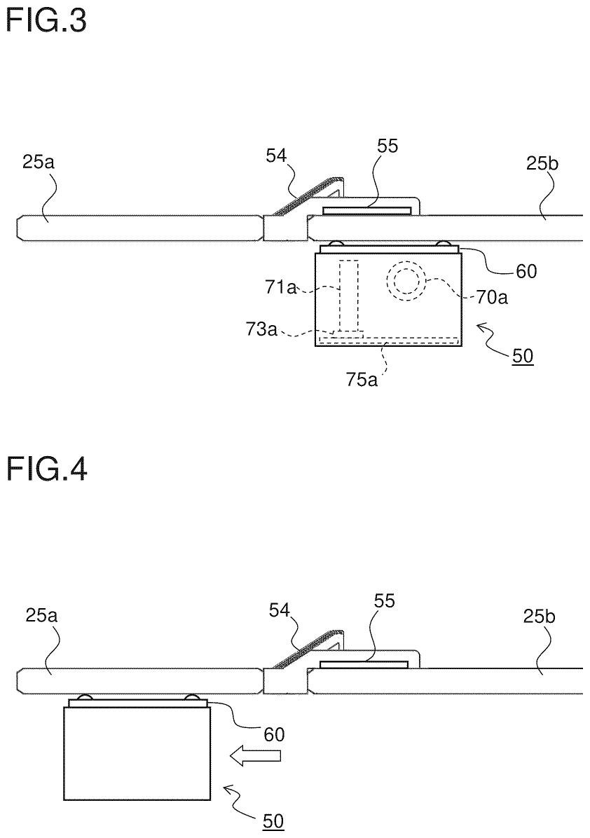

FIGS. 3 and 4 are enlarged views around the front-side reading module 50 and the front-side white reference plate 55 in FIG. 2, respectively showing a state where the front-side reading module 50 is at a reference position (home position) and a state where it is at an automatic-reading position. The front-side reading module 50 is a reading module of a CIS (contact image sensor) type.

As shown in FIG. 3, the front-side reading module 50 includes inside it a light source 70a, a light-collecting lens 71a composed of a plurality of lenses, and a CMOS (complementary MOS) sensor 73a as a reading means. The CMOS sensor 73a is supported on a substrate 75a. Light emitted from the light source 70a is reflected on the document (unshown) and is then collected by the light-collecting lens 71a to be directed to the CMOS sensor 73a. The front-side reading module 50 makes contact with the bottom face of the contact glass 25 via a slider 60.

Here, as an example of the reading method for the front-side reading module 50, a unit-magnification optical system is taken that does not use a mirror but uses a CMOS sensor 73 as an image sensor; instead, a reduction optical system can be used that uses a plurality of mirrors and optical lenses along with, as an image sensor, what is called a CCD (charge-couple device) and that reads an image by forming a reduced image of it with those optical lenses.

In the above configuration, when a document image is read by the stationary-document method, first, the automatic document feeder 27 is opened and a document (not shown) is placed on the hand-placed document glass 25b with the front side down. Then the automatic document feeder 27 is closed and, while the image face of the document is irradiated with light from the light source 70a, the front-side reading module 50 is moved at a predetermined speed from the scanner home end (at left in FIG. 2) toward the scanner return end (at right in FIG. 2). As a result, the light reflected from the image face, which is image light, is focused on the CMOS sensor 73a. In the CMOS sensor 73a, the focused image light is resolved into pixels and converted into an electrical signal corresponding to the density at each pixel, thereby achieving image reading.

On the other hand, when a document image is read by the sheet-through method, with the automatic document feeder 27 closed, as shown in FIG. 4, the front-side reading module 50 is moved to an automatic reading position (immediately below the automatic reading glass 25a). Then the automatic document feeder 27 conveys the document one sheet after another toward the automatic reading glass 25a and, while the front face of the document passing across the automatic reading glass 25a is irradiated with light form the light source 70a, the image light reflected from the image face is focused on the CMOS sensor 73a, thereby achieving image reading. In either reading method, the image signal read by the front-side reading module 50 is converted into a digital signal and is then fed to a temporary storage 94 (see FIG. 6).

FIG. 5 is an enlarged view around the back-side reading module 51 in FIG. 2. The back-side reading module 51 is a reading module of a CIS (contact image sensor) type similar to the front-side reading module 50. As shown in FIG. 5, the back-side reading module 51 includes, inside it, a light source 70b, a light-collecting lens 71b composed of a plurality of lenses, and a CMOS (complementary MOS) sensor 73b as a reading means. The CMOS sensor 73b is supported on a substrate 75b.

The back side of the document passing across the back-side reading module 51 is irradiated with light from the light source 70b, and the reflected light (image light) reflected from the image face is collected by the light-collecting lens 71b and is focused on the CMOS sensor 73b. In the CMOS sensor 73b, the focused image light is resolved into pixels and converted into an electrical signal corresponding to the density at each pixel, thereby achieving image reading.

FIG. 6 is a block diagram showing one example of control paths used in the image forming apparatus 100 according to the embodiment. When the image forming apparatus 100 is in use, various kinds of control are performed for different parts of the image forming apparatus 100 and thus the control paths in the entire image forming apparatus 100 are complicated. For simplicity's sake, of those control paths, the following description focuses on only those which are necessary to implement the present disclosure.

The operation portion 80 includes a liquid crystal display 81 and LEDs 82 for indicating various states, and displays the status of the image forming apparatus 100, the progress of image formation, and the number of copies printed. Various settings for the image forming apparatus 100 are made from a printer driver on a personal computer.

The operation portion 80 also includes a start button with which a user can enter an instruction to start image formation, a stop/clear button that the user can use, for example, to stop image formation, a reset button that the user can use to get the various settings on the image forming apparatus 100 back to the default ones.

A module driving motor 83 makes the front-side reading module 50 reciprocate in the sub-scanning direction (left-right direction in FIG. 2) when a document image is read by the stationary-document method. The module driving motor 83 moves the front-side reading module 50 to the automatic-reading position when a document image is read by the sheet-through method. The module driving motor 83 is a stepping motor, and the control portion 90 can sense the position of the front-side reading module 50 according to the number of driving pulses for the module driving motor 83.

The control portion 90 includes at least a CPU (central processing unit) 91 as a central arithmetic processor, a ROM (read-only memory) 92 as a memory for reading only, a RAM (random-access memory) 93 as a readable/writable memory, a temporary memory 94 for temporarily storing image data and the like, a plurality of (here, two) I/Fs (interfaces) 96 for transmitting control signals to different devices in the image forming apparatus 100 and receiving input signals from the operation portion 80, and a reading processing portion 97. The control portion 90 can be disposed anywhere in the image forming apparatus 100.

The control portion 90 transmits control signals to different blocks and devices in the image forming apparatus 100 from the CPU 91 via the I/Fs 96. From those different blocks and devices, signals indicating their states, and also input signals, are transmitted via the I/Fs 96 to the CPU 91. The blocks and devices controlled by the control portion 90 include, for example, the image forming portion 3, the image reading portion 6, the automatic document feeder 27, and the operation portion 80.

The ROM 92 stores programs for the control of the image forming apparatus 100, data that are not changed during the use of the image forming apparatus 100, such as values needed for its control, and the like. The RAM 93 stores necessary data produced in the course of the control of the image forming apparatus 100, data temporarily needed for the control of the image forming apparatus 100, and the like. The temporary storage 94 temporarily stores an image signal that is fed in from an image input portion (not shown), which receives image data transmitted from the image reading portion 6, and that is then converted into a digital signal.

The reading processing portion 97 performs a reading process by the stationary-document method (stationary reading process) in which it, using the front-side reading module 50, reads image data from a document placed on the hand-placed document glass 25b. The reading processing portion 97 also performs a reading process by the sheet-through method (conveying reading process) in which it, using the front-side reading module 50 and the back-side reading module 51, reads the image data from the front and back sides of a document automatically conveyed by the document feed tray 29.

On various occasions as at power-on of the image forming apparatus 100, on its recovery from a power-saving state (sleep mode), in response to a predetermined change in temperature or humidity, or at the start of an image reading process, some processes are performed that are necessary for initial setting and adjustment of the front-side reading module 50 and the back-side reading module 51. Those processes include black reference data acquisition, white reference data acquisition, offset adjustment, and gain adjustment.

In black reference data acquisition, with the light source 70a in the front-side reading module 50 or the light source 70b in the back-side reading module 51 extinguished, the output voltages (output levels) of the CMOS sensors 73a and 73b are acquired as light-amount data (black reference data).

In white reference data acquisition, with the light source 70a in the front-side reading module 50 or the light source 70b in the back-side reading module 51 lit, the light emitted from the light source 70a or 70b is reflected from the front-side white reference plate 55 or the back-side white reference plate 57, and is then collected by the light-collecting lens 71a or 71b to be directed to the CMOS sensor 73a or 73b. In this state the output voltages (output levels) of the CMOS sensors 73a and 73b are acquired as light-amount data (white reference data).

In offset adjustment, with the light source 70a in the front-side reading module 50 or the light source 70b in the back-side reading module 51 unlit, the output voltages (output levels) of the CMOS sensors 73a and 73b are adjusted to be a constant voltage. In gain adjustment, with the light source 70a in the front-side reading module 50 or the light source 70b in the back-side reading module 51 lit, the output voltages (output levels) of the CMOS sensors 73a and 73b are adjusted to be a constant voltage.

In the image reading portion 6 according to the embodiment, for low-profiling of the image reading portion 6 (to reduce its dimension in the height direction), the back-side reading module 51 is disposed at a position opposite the front-side reading module 50. During document reading by the sheet-through method, they are disposed in such a positional relationship that the light emitted from the light source 70a in the front-side reading module 50 (or the light source 70b in the back-side reading module 51) does not act as extraneous disturbing light to the CMOS sensor 73b in the back-side reading module 51 (or the CMOS sensor 73a in the front-side reading module 50).

However, during document reading by the sheet-through method, the front-side reading module 50 moves, with the light source 70a lit, from below the front-side white reference plate 55 to the automatic-reading position. Thus, the light emitted from the light source 70a may act as extraneous disturbing light to the CMOS sensor 73b in the back-side reading module 51.

Moreover, in a case where no open/close sensing function is provided to sense whether the automatic document feeder 27 is in a closed state in contact with the contact glass 25 or in an open state away from the contact glass 25, performing black reference data acquisition with the automatic document feeder 27 in the open position results in the CMOS sensor 73a or 73b receiving extraneous disturbing light and this may make it impossible to acquire accurate black reference data.

To cope with that, in the embodiment, when duplex reading is requested during image reading operation by the sheet-through method, before white reference data acquisition for the front-side reading module 50 is performed, for the back-side reading module 51, offset adjustment, gain adjustment, and black and white reference data acquisition are performed. After the completion of offset adjustment, gain adjustment, and black and white reference data acquisition for the back-side reading module 51, white reference data for the front-side reading module 50 is acquired.

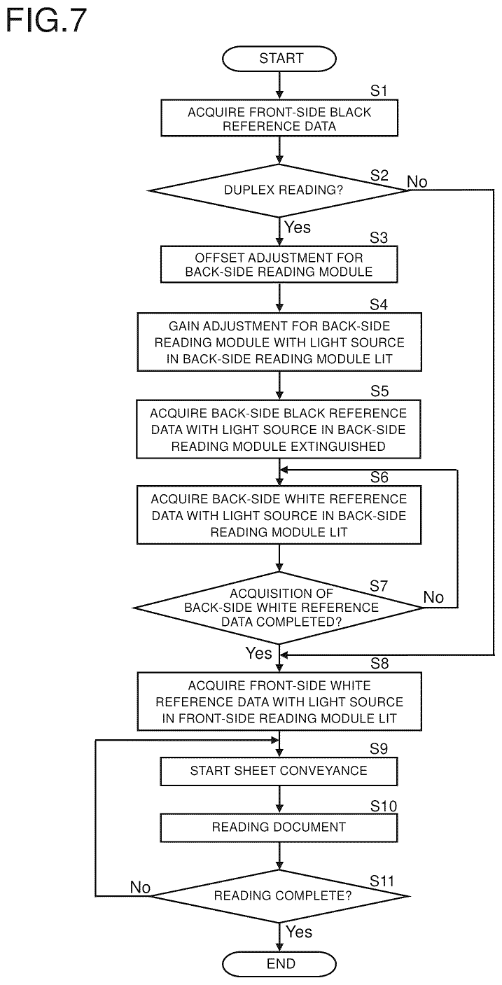

FIG. 7 is a flow chart showing an example of control for document reading by the sheet-through method in the image reading portion 6 according to the embodiment. With reference also to FIGS. 1 to 6 as necessary, along the steps in FIG. 7, a description will be given of lighting control for the light source 70a in the front-side reading module 50 and the light source 70b in the back-side reading module 51 in the sheet-through method. It is assumed that, in an initial state, the front-side reading module 50 is disposed at the reference position (home position) shown in FIG. 3. It is also assumed that, for the front-side reading module 50, offset adjustment and gain adjustment are performed at power-on of the image forming apparatus 100.

When document reading by the sheet-through method is requested, the control portion 90 acquires front-side black reference data (Step S1). Specifically, with the light source 70a in the front-side reading module 50 extinguished, the output level of the CMOS sensor 73a is acquired as front-side black reference data.

Next, the control portion 90 checks whether the requested document reading process is a duplex reading process (Step S2). If it is a duplex reading process (Step S2, Yes), with the light source 70b in the back-side reading module 51 extinguished, the control portion 90 performs offset adjustment for the back-side reading module 51 (Step S3). Next, the control portion 90 lights the light source 70b in the back-side reading module 51, and then performs gain adjustment for the back-side reading module 51 (Step S4).

Subsequently, the control portion 90 extinguishes the light source 70b in the back-side reading module 51, and then acquires back-side black reference data (Step S5). Specifically, with the light source 70b in the back-side reading module 51 extinguished, the output level of the CMOS sensor 73b is acquired as back-side black reference data.

If back-side black reference data is acquired first and then gain adjustment for the back-side reading module 51 is performed, then, with the light source 70b extinguished, the output level of the CMOS sensor 73b may vary. To prevent that, before back-side black reference data is acquired, gain adjustment for the back-side reading module 51 is performed. This increases the number of times that the light source 70b has to be extinguished and lit repeatedly but allows acquisition of more accurate back-side black reference data.

Subsequently, the control portion 90 lights the light source 70b in the back-side reading module 51, and then acquires back-side white reference data (Step S6). Specifically, with the light source 70b in the back-side reading module 51 lit, the output level of the CMOS sensor 73b is acquired as back-side white reference data. In this embodiment, while either the back-side reading module 51 or the back-side white reference plate 57 is swung in a direction orthogonal to the conveyance direction with a swinging mechanism (not shown), back-side white reference data is acquired a plurality of times.

Next, the control portion 90 checks whether the acquisition of back-side white reference data is complete (Step S7). If the acquisition of back-side white reference data is complete (S7, Yes), the control portion 90 lights the light source 70a in the front-side reading module 50, and then acquires front-side white reference data (Step S8). Specifically, with the front-side reading module 50 disposed at the reference position (immediately below the front-side white reference plate 55), with the light source 70a lit, the output level of the CMOS sensor 73a is acquired as front-side white reference data.

On the other hand, if the requested image reading is simplex reading (Step S2, No), the control portion 90 acquires front-side black reference data (Step S1) but then does not perform offset adjustment, back-side black reference data acquisition, gain adjustment, and back-side white reference data acquisition for the back-side reading module 51; instead the control portion 90, with the light source 70a in the front-side reading module 50 lit, acquires front-side white reference data (Steps S8 and S9).

While acquiring front-side white reference data, the control portion 90, with the light source 70a in the front-side reading module 50 lit, moves the front-side reading module 50 from the reference position to immediately below the automatic reading glass 25a (automatic-reading position) and starts document conveyance (Step S9) to read the document (Step S10). Then the control portion 90 checks whether the predetermined number of sheets have been read as requested (Step S11) and, if the reading still continues (Step S11, No), returns to Step S9 to continue the conveyance and reading of the document. If the predetermined number of sheets have been read (Step S11, Yes), the control portion 90 ends the process.

With the example of control shown in FIG. 7, if the requested document reading process is a duplex printing process, before front-side white reference data is acquired with the light source 70a in the front-side reading module 50 lit, offset adjustment, back-side black reference data acquisition, gain adjustment, and white reference data acquisition for the back-side reading module 51 are performed in this order.

As described above, immediately after duplex reading is requested, the automatic document feeder 27 is in the closed state and the back-side reading module 51 can properly read the back-side white reference plate 57 without being affected by extraneous disturbing light. This eliminates the need to provide the automatic document feeder 27 with an open/close sensing function and helps reduce the number of components and the cost of the automatic document feeder 27.

Moreover, until offset adjustment, gain adjustment, and black and white reference data acquisition for the back-side reading module 51 are complete, the front-side reading module 50 can be kept at rest at a predetermined position with the light source 70a extinguished. This makes it possible to properly complete the setting for reading by the back-side reading module 51 without being affected by the light emitted from the light source 70a.

After completion of the acquisition of back-side white reference data is confirmed, with the light source 70a in the front-side reading module 50 lit, front-side white reference data is acquired. Since the front-side white reference plate 55 is placed below the conveyance guide 54, when the white reference data for the front-side reading module 50 is acquired, even with the automatic document feeder 27 in the open state, there is no risk of extraneous disturbing light entering the light-collecting lens 71a in the front-side reading module 50.

The front-side reading module 50, while moving to the automatic-reading position, reads the front-side white reference plate 55 to acquire front-side white reference data; here, owing to the positional relationship such that the light emitted from the light source 70b in the back-side reading module 51 does not enter the light-collecting lens 71a in the front-side reading module 50, there is no risk of the light emitted from the back-side reading module 51 exerting an effect as extraneous disturbing light. Thus, after the acquisition of back-side white reference data, the back-side reading module 51 can leave the light source 70b lit for image reading.

The timing of starting the conveyance of the document: it is preferable to start the conveyance of the document after the acquisition of front-side white reference data for the front-side reading module 50, either before the start of the movement of the front-side reading module 50 to the automatic-reading position or during that movement, as in simplex reading. By in this way starting the conveyance of the document without waiting for completion of the movement of the front-side reading module 50 to the automatic-reading position, it is possible to reduce the time from the request of reading to the completion of reading.

The present disclosure is not limited by the embodiment described above and allows for many modifications without departure from the spirit of the present disclosure. For example, while the above embodiment takes as an example of an image reading device one that is composed of an image reading portion 6 and an automatic document feeder 27 and that includes a back-side reading module 51 disposed in the automatic document feeder 27 and a front-side reading module 50 disposed in the image reading portion 6, the present disclosure is equally applicable to an image scanner that is used as a separate unit from the image forming apparatus 100.

The present disclosure finds applications in image reading devices that can read the images on the front and back sides of a document simultaneously by using a front-side reading module and a back-side reading module. Based on the present disclosure, it is possible to provide an image reading device that can acquire better two-side read images by controlling the lighting of light sources in the front-side and back-side reading modules with timing insusceptible to an effect of extraneous disturbing light, and to provide an image forming apparatus comprising the image reading device.

What is claimed is:

1. An image reading device comprising:
a contact glass on which a document is placed;
an automatic document feeder provided on a top face of the contact glass so as to be openable and closable with respect thereto, the automatic document feeder conveying the document to an automatic reading position on the contact glass;
a first reading module disposed below the contact glass so as to be reciprocable in a sub-scanning direction, the first reading module being operable to read an image on a front side of
a stationary document placed on the contact glass and
a conveyed document conveyed to the automatic reading position by the automatic document feeder;
a second reading module disposed in the automatic document feeder, the second reading module being operable to read an image on a back side of the conveyed document;
a first white reference member disposed opposite the first reading module at a position different from the automatic reading position;
a second white reference member disposed opposite the second reading module;
a control portion that controls the first and second reading modules,
wherein
the first reading module includes:
a first light source; and
a first sensor that reads, as image light, reflected light of light shone from the first light source to the conveyed document,
the second reading module includes:
a second light source; and
a second sensor that reads, as image light, reflected light of light shone from the second light source to the conveyed document,
when the control portion performs, as a conveying reading process for reading an image on the conveyed document, a duplex reading process whereby the images on the front and back sides of the conveyed document are read simultaneously, after the duplex reading process is requested the control portion performs offset adjustment, gain adjustment, and acquisition of back-side black reference data and back-side white reference data for the second reading module.

2. The image reading device according to claim 1, wherein
at power-on of the image reading device, the control portion performs the offset adjustment and the gain adjustment for the first reading module and, after the conveying reading process is requested, the control portion performs the acquisition of front-side black reference data and front-side white reference data.

3. The image reading device according to claim 2, wherein
when the duplex reading process is requested, before performing the offset adjustment, the gain adjustment, and the acquisition of the back-side black reference data and the back-side white reference data for the second reading module, the control portion, with the first light source in the first reading module extinguished, acquires the front-side black reference data, and
after completion of the offset adjustment, the gain adjustment, and the acquisition of the back-side black reference data and the back-side white reference data for the second reading module, the control portion, with the first light source in the first reading module lit, acquires the front-side white reference data.

4. The image reading device according to claim 1, wherein
when the conveying reading process is requested, the control portion, while acquiring the front-side white reference data, moves the first reading module to the automatic-reading position and, before completing moving the first reading module to the automatic-reading position, the control portion starts to convey the conveyed document.

5. The image reading device according to claim 1, wherein
the image reading device does not have a mechanism that senses whether the automatic document feeder is in a closed state in which the automatic document feeder is in contact with the contact glass or in an open state in which the automatic document feeder stays away from the contact glass.

6. An image forming apparatus comprising the image reading device according to claim 1.
